(19) United States
(12) Patent Application Publication
(10) Pub. No.: US 2015/0077977 A1
(43) Pub. Date: Mar. 19, 2015

(54) BACKLIGHT MODULE AND LCD

(71) Applicants: Yubo Gu, Shenzhen (CN); Liuyang Yang, Shenzhen (CN); Pei Jia, Shenzhen (CN)

(72) Inventors: Yubo Gu, Shenzhen (CN); Liuyang Yang, Shenzhen (CN); Pei Jia, Shenzhen (CN)

(73) Assignee: Shenzhen China Star Optoelectronics Technology Co., Ltd., Shenzhen (CN)

(21) Appl. No.: 13/522,967

(22) PCT Filed: Jun. 7, 2012
(86) PCT No.: PCT/CN2012/076555

§ 371 Date: Jul. 19, 2012

(30) Foreign Application Priority Data
Jun. 6, 2012 (CN) 201210183599.8

(51) Int. Cl. G02F 1/1335; G09F 13/14

(52) U.S. Cl. CPC G02F 1/133605; G09F 13/14; G02F 1/133603; G02F 1/133608; G09F 2013/0422
USPC 362/97.3

(57) ABSTRACT

The present invention provides a backlight module and an LCD. The backlight module includes a light source, a PCB, and a reflector. The light source includes a light output surface. The light output surface is parallel to the PCB with a light source distance therebetween. The reflector is disposed beside the light source and has a reflecting layer. The reflecting layer is outward curved in an opposite direction of the PCB, and there is a maximum distance between the reflecting layer and the PCB, and the maximum distance is larger than the light source distance.

### FIELD OF THE INVENTION

The present invention relates to a liquid crystal display (LCD) technology, and especially to a backlight module and an LCD.

### BACKGROUND OF THE INVENTION

With a growing development in LCD production techniques, there are high demands for the production efficiency of the LCD.

Referring to FIG. 1, FIG. 1 is a schematic drawing illustrating a light-emitting diode (LED) backlight module in prior art. The backlight module herein includes an LED 11, a printed circuit board (PCB) 12, a conductive layer 13, and pins 14. The LED 11 has a light output surface 111.

The LED 11 herein is disposed on the PCB 12, and the conductive layer 13 is disposed on the inside of the PCB 12. The LED 11 is coupled to the conductive layer 13 via the pins 14.

When light emitted from the light output surface 111 of the LED 11 passes through optical films (not shown), a part of the light is reflected from the optical films. In order to effectively use the reflected light, a reflecting layer 15 is usually disposed on the conductive layer 13. The reflecting layer 15 can further reflect the reflected light back to the optical films, so as to increase utilization rate of the light.

However, there is a reflecting region 16 between a surface where the light output surface 111 is located and the reflecting layer 15. The reflecting region 16 has a reflecting height H1, which is a distance between the surface where the light output surface 111 of the LED 11 is located and the reflecting layer 15. Due to the existence of the reflecting region 16, the light reflected from the optical films largely dissipates in passing through the reflecting region 16, such that the utilization rate of the light reflected from the optical films decreases.

Moreover, the pins 14 extend for a length H2 toward the LED 11 in a lengthwise direction A of the PCB 12, and the reflecting layer 15 can not be disposed on the pins 14. Thus, the reflecting layer 15 can not extend to a region where the pins 14 is located, such that the region can not reflect the reflected light, hence the utilization rate of the reflected light further decreases.

To solve the above-mentioned problem, a support bracket 17 is generally disposed between the reflecting layer 15 and the conductive layer 13, as shown in FIG. 2.

In the backlight module shown in FIG. 2, the support brackets 17 support the reflecting layer 15, so that the reflecting layer 15 is flush with the surface where the light output surface 111 of the LED 11 is located. This manner can prevent the light from dissipating due to the existence of the reflecting region 16.

However, because plenty of space still exists between the light output surface 111 of the LED 11 and the optical films, the light dissipation still exists; thus, the light reflected from the optical films still can not be effectively utilized in this manner.

### SUMMARY OF THE INVENTION

An objective of the present invention is to provide an backlight module which can solve the drawback that the light reflected from the optical films can not be effectively utilized due to the plenty of space existing between the light output surface of the LED and the optical films in the backlight module of the prior art.

To achieve the foregoing objective, a backlight module constructed in the present invention includes a light source and a PCB. The light source is disposed on an inside of the PCB. The light source includes a light output surface, and the light output surface is parallel to the PCB with a light source distance therebetween. The backlight module further includes a reflector. A support bracket is disposed between the reflector and the PCB, and the support bracket is utilized to support and fix the reflector.

The reflector herein is disposed beside the light source, and the reflector has a reflecting layer. The reflecting layer herein has a curved surface, and the reflecting layer is outward curved in an opposite direction of the PCB. There is a maximum distance between the reflecting layer and the PCB, and the maximum distance is larger than the light source distance.

In the backlight module of the present invention, the reflector has a bottom, and there is a supporting distance between the bottom and the PCB. The supporting distance is less than the light source distance.

In the backlight module of the present invention, the curved surface is formed by a plurality of flat surfaces coupling each other.

In the backlight module of the present invention, the curved surface is an arced surface.

Another objective of the present invention is to provide an backlight module which can solve the drawback that the light reflected from the optical films can not be effectively utilized due to the plenty of space existing between the light output surface of the LED and the optical films in the backlight module of the prior art.

To achieve the foregoing objective, a backlight module constructed in the present invention includes a light source and a PCB. in which the light source is disposed on an inside of the PCB. The light source includes a light output surface, and the light output surface is parallel to the PCB with a light source distance therebetween. The backlight module further includes a reflector.

The reflector is disposed beside the light source, and the reflector has a reflecting layer. The reflecting layer is outward curved in an opposite direction of the PCB. There is a maximum distance between the reflecting layer and the PCB, and the maximum distance is larger than the light source distance.

In the backlight module the present invention, a support bracket is disposed between the reflector and the PCB, and the support bracket is utilized to support and fix the reflector.

In the backlight module the present invention, the reflector has a bottom. There is a supporting distance between the bottom and the PCB, and the supporting distance is less than the light source distance.

In the backlight module the present invention, the reflecting layer has a curved surface.

In the backlight module the present invention, the curved surface is formed by a plurality of flat surfaces coupling each other.

In the backlight module the present invention, the curved surface is an arced surface.

Yet another objective of the present invention is to provide an LCD which can solve the drawback that the light reflected from the optical films can not be effectively utilized due to the plenty of space existing between the light output surface of the LED and the optical films in the backlight module of the prior art.

To achieve the foregoing objective, an LCD constructed in the present invention includes a backlight module. The backlight module includes a light source and a PCB, in which the light source is disposed on an inside of the PCB. The light source includes a light output surface, and the light output surface is parallel to the PCB with a light source distance therebetween. The backlight module further includes a reflector.

The reflector is disposed beside the light source, and the reflector has a reflecting layer. The reflecting layer is outward curved in an opposite direction of the PCB. There is a maximum distance between the reflecting layer and the PCB, and the maximum distance is larger than the light source distance.

In the LCD of the present invention, a support bracket is disposed between the reflector and the PCB, and the support bracket is utilized to support and fix the reflector.

In the LCD of the present invention, the reflector has a bottom, and there is a supporting distance between the bottom and the PCB. The supporting distance is less than the light source distance.

In the LCD of the present invention, the reflecting layer has a curved surface.

In the LCD of the present invention, the curved surface is formed by a plurality of flat surfaces coupling each other.

In the LCD of the present invention, the curved surface is an arced surface.

In comparison with the prior art, the reflecting layer of the reflector is configured to be arranged in the curved surface according to the present invention, and the maximum distance between the reflecting layer and the PCB is larger than the distance between the light source light output surface and the PCB. As a result, paths that the light reflected from the optical films reaches the reflector are reduced, so that the light dissipation resulting from the reflected light with long paths can be avoided. Thus, the utilization rate of the light reflected from the optical films is increased, thereby increasing luminous efficiency of the backlight module.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a schematic drawing illustrating a backlight module in prior art;

FIG. 2 is a schematic drawing illustrating another backlight module in prior art;

FIG. 3 a schematic drawing illustrating a backlight module according to a first preferred embodiment of the present invention;

FIG. 4 is a schematic drawing illustrating a light source, pins, and a conductive layer in FIG. 3;

FIG. 5 is a schematic sectional view illustrating a reflector in FIG. 3;

FIG. 6 is a schematic drawing illustrating a reflecting layer of the reflector in FIG. 3;

FIG. 7 is a schematic drawing illustrating a backlight module according to a second preferred embodiment of the present invention; and

FIG. 8 is a schematic drawing illustrating a backlight module according to a third preferred embodiment of the present invention.

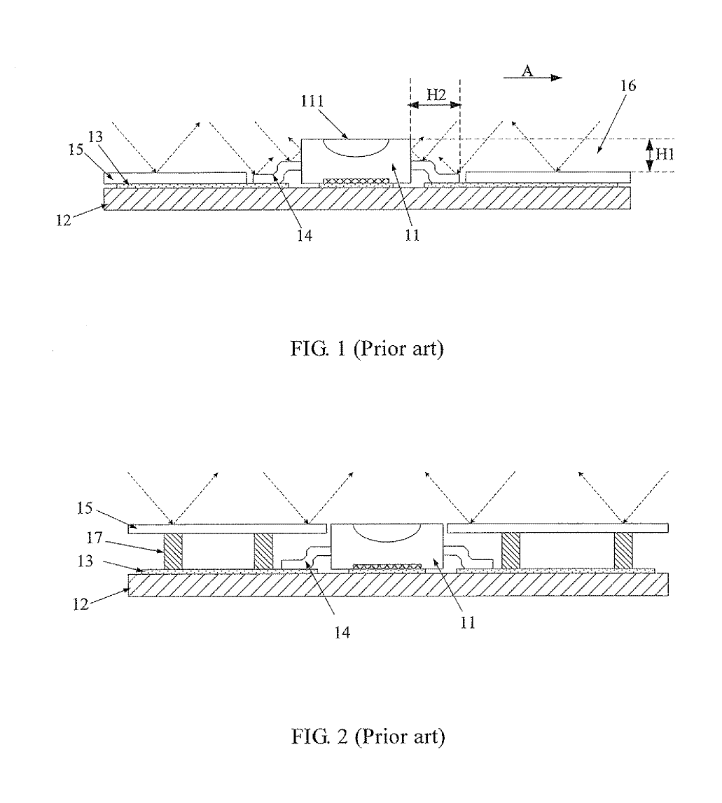

### DETAILED DESCRIPTION OF THE PREFERRED EMBODIMENTS

Descriptions of the following embodiments refer to attached drawings which are utilized to exemplify specific embodiments. Directional terms mentioned in the present invention, such as “top” and “down” “front”, “rear”, “left”, “right”, “inside”, “outside”, “side” and so on are only directions with respect to the attached drawings. Therefore, the used directional terms are utilized to explain and understand the present invention but not to limit the present invention. In different drawings, the same reference numerals refer to like parts throughout the drawings.

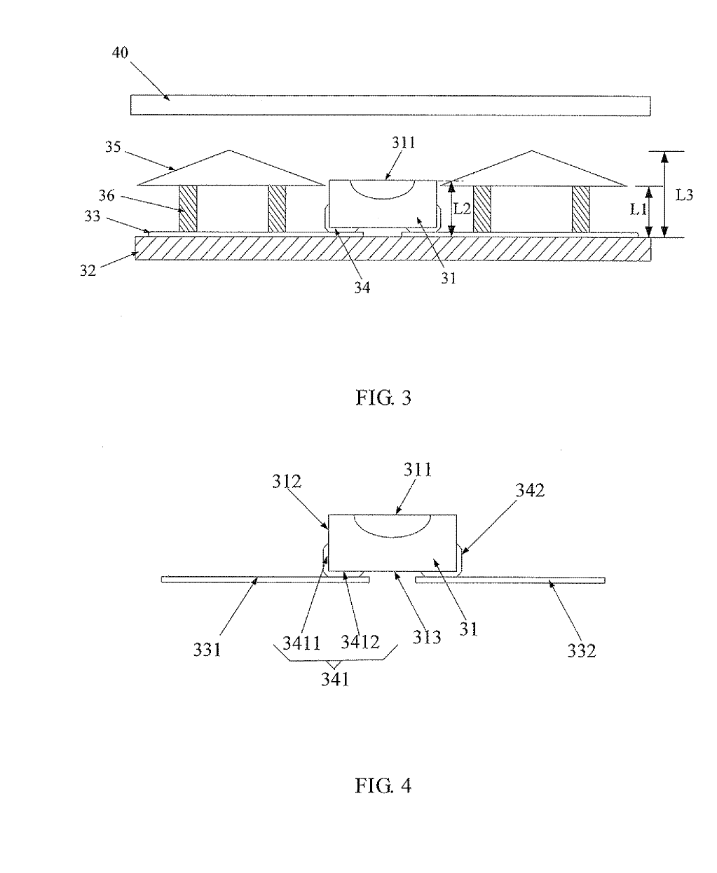

FIG. 3 is a schematic drawing illustrating a backlight module according to a first preferred embodiment of the present invention.

The backlight module includes a light source 31, a PCB 32, a conductive layer 33, pins 34, reflectors 35, and support brackets 36. The light source 31 includes a light output surface 311, and the backlight module further includes optical film 40.

The light source 31 herein is disposed on the PCB 32, and the light output surface 311 of the light source 31 is parallel to the PCB 32. The conductive layer 33 is disposed on an inside of the PCB 32. Referring to FIG. 4 with FIG. 3, the conductive layer 33 includes a first conductive layer 331and a second conductive layer 332. The first conductive layer 331 and the second conductive layer 332 are respectively disposed on both sides of the light source 31.

The pins 34 include a first pin 341 and a second pin 342. The light source 31 is coupled to the first conductive layer 331 via the first pin 341, and coupled to the second conductive layer 332 via the second pin 342.

Referring to FIG. 4 again, using the first pin 341 as an example, the first pin 341 is a bending structure which includes a first bending port 3411 and a second bending part 3412. The first bending port 3411 abuts on a side 312 of the light source 31, and the second bending port 3412 abuts on a bottom side 313 of the light source 31. Furthermore, the second bending part 3412 is simultaneously coupled to the first conductive layer 331 for realizing signal transmission between the PCB 32 and the light source 31. The second pin 342 has the same structure and function as the first pins 341, so no further detail will be provided herein.

The pins 34 of the present invention are designed to be the bending structures, which respectively abut the side and the bottom side of the light source 31, for coupling to the bottom side of the light source 31 and simultaneously coupling to the conductive layer 33. It does not need too much space, and it is a disadvantage to the arrangement of other components within the backlight module. For example, the support bracket 36 can be flexibly disposed beside the light source 31.

Referring back to FIG. 3, the support bracket 36 is disposed between the PCB 32 and the reflector 35. More specifically, it is disposed between the conductive layer 33 and the reflector 35. In the embodiment, the support bracket 36 is utilized to support and fix the reflector 35.

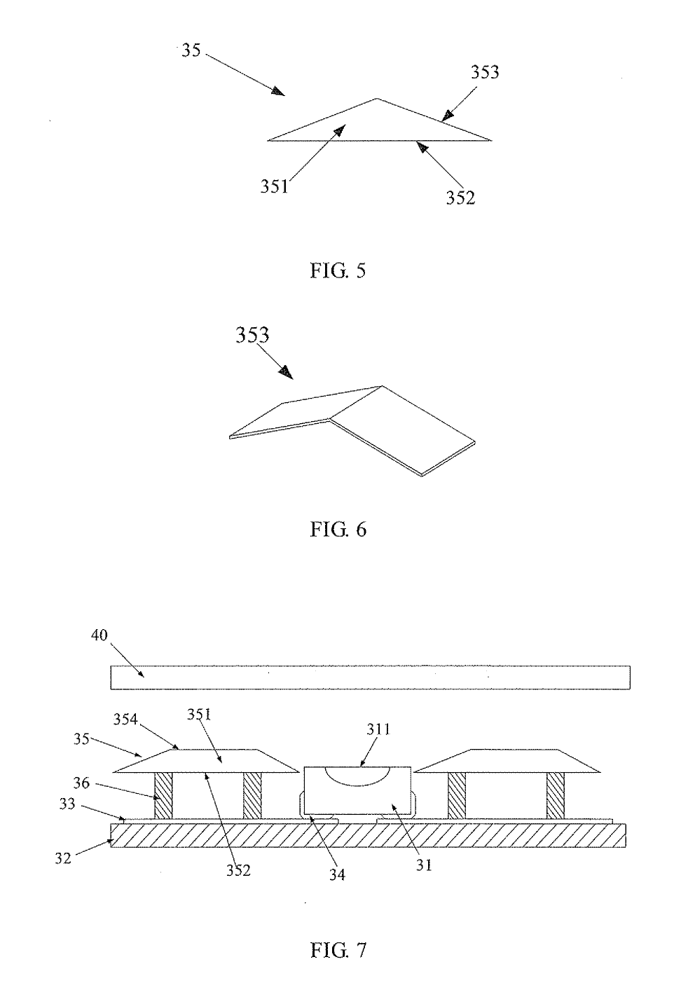

Referring to FIG. 5 with the foregoing drawings, the reflector 35 includes a reflector body 351, and includes a bottom 352 and a reflecting layer 353 located at a surface layer of the reflector body 351. The bottom 352 herein is parallel to the PCB 32, so that the support bracket 36 can stably support the reflector 35.

Referring back to FIG. 3, there is a supporting distance L1 between the bottom 352 and the PCB 32; there is a light source distance L2 between the light output surface 311 of the light source 31 and the PCB 32; and there is a maximum distance L3 between the reflecting layer 353 and the PCB 32, in which L1≦L2, and L2<L3. The condition of L1≦L2 in the present invention can ensure that the light emitted from the light source 31 can not be incident on the bottom 352 of the reflector 35. The condition of L2<L3 in the present invention can reduce the paths that the light reflected from the optical film 40 reaches the reflector 35, so as to increase the utilization rate of the light.

Moreover, he supporting distance L1 and the light source distance L2 are within a predetermined range, such as 1.0 mm to 5.0 mm, thereby ensuring that the light reflected from the optical film 40 can be utilized effectively.

In the present invention, the reflecting layer 353 is a curved surface reflecting layer. For instance, the reflecting layer 353 can have a curved surface structure formed by a plurality of flat surfaces being coupled with each other and bent. In the first preferred embodiment, the flat surfaces are bent to form a triangle structure, such as the reflecting layer 353 shown in FIG. 6.

The operating principle of the backlight module of the first preferred embodiment shown in FIG. 3 to FIG. 6 is as follows.

In working processes of the backlight module, after the light emitted from the light source 31 reaches the optical film 40, most of the light passes through the optical film 40, but a part of the light still'is reflected from the optical film 40.

The above-mentioned light reflected from the optical film 40 is incident on the reflector 35, and then goes back to and passes through the optical film 40 after being reflected by the reflecting layer 353 of the reflector 35.

Because of the support of the support bracket 36, the support bracket 36 is closer to the optical film. Moreover, the reflecting layer 353 of the reflector 35 is configured to bend in the curved surface, and the maximum distance L3 between the reflecting layer 353 and the PCB 32 is larger than the light source distance L2 between the light output surface 311 of the light source 31 and the PCB 32, so that the reflecting layer 353 is more closer to the optical film 40 for extremely reducing the distance that the light reflected from the optical film 40 reaches the reflector 35. Thus, the light dissipation due to the excessive distance can be avoided, and the light reflected from the optical film 40 can be effectively utilized, so as to increase the luminous efficiency of the backlight module.

FIG. 7 is a schematic drawing illustrating a backlight module according to a second preferred embodiment of the present invention. The difference between the second embodiment and the first embodiment shown in FIG. 3 is that the reflecting layer 354 of the reflector 35 in the second embodiment as shown in FIG. 7 has a curved surface structure formed by the plurality of flat surfaces being bent, and the flat surfaces are bent to form a trapezoid structure.

The structure and operating principle with regard to the second preferred embodiment as shown in FIG. 7 please refer to the description for the first preferred embodiment as shown in FIG. 3, so no further detail will be provided herein.

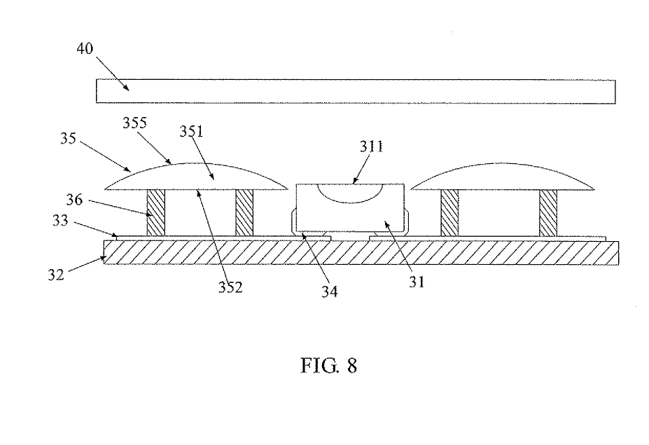

FIG. 8 is a schematic drawing illustrating a backlight module according to a third preferred embodiment of the present invention. The difference between the third embodiment and the first embodiment shown in FIG. 3 is that the reflecting layer 355 of the reflector 35 in the third embodiment as shown in FIG. 8 is an arced surface reflecting layer.

The structure and operating principle with regard to the third preferred embodiment as shown in FIG. 8 please refer to the description for the first preferred embodiment as shown in FIG. 3, so no further detail will be provided herein.

An LCD is further provided in the present invention. The LCD includes the backlight module which is provided in the present invention. Whereas the backlight module has been described in detail mentioned above, no further detail will be provided herein.

In comparison with the prior art, the reflecting layer of the reflector is configured to be arranged in the curved surface according to the present invention, and the maximum distance between the reflecting layer and the PCB is larger than the distance between the light source light output surface and the PCB. As a result, paths that the light reflected from the optical films reaches the reflector are reduced, so that the light dissipation resulting from the reflected light with long paths can be avoided. Thus, the utilization rate of the light reflected from the optical films is increased, thereby increasing luminous efficiency of the backlight module.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A backlight module, comprising a light source and a printed circuit board (PCB), the light source disposed on an inside of the PCB, the light source comprising a light output surface, the light output surface parallel to the PCB with a light source distance therebetween, the backlight module further comprising a reflector, a support bracket disposed between the reflector and the PCB, the support bracket utilized to support and fix the reflector;
wherein the reflector is disposed beside the light source, and the reflector has a reflecting layer, wherein the reflecting layer has a curved surface and the reflecting layer is outward curved in an opposite direction of the PCB, and there is a maximum distance between the reflecting layer and the PCB, and the maximum distance is larger than the light source distance.

2. The backlight module according to claim 1, wherein the reflector further has a bottom and there is a supporting distance between the bottom and the PCB, and the supporting distance is less than the light source distance.

3. The backlight module according to claim 1, wherein the curved surface is formed by a plurality of flat surfaces coupling each other.

4. The backlight module according to claim 1, wherein the curved surface is an arced surface.

5. A backlight module, comprising a light source and a PCB, the light source disposed on an inside of the PCB, the light source comprising a light output surface, the light output surface parallel to the PCB with a light source distance therebetween, the backlight module further comprising a reflector,
wherein the reflector is disposed beside the light source, and the reflector has a reflecting layer, wherein the reflecting layer is outward curved in an opposite direction of the PCB, and there is a maximum distance between the reflecting layer and the PCB, and the maximum distance is larger than the light source distance.

6. The backlight module according to claim 5, wherein a support bracket is disposed between the reflector and the PCB, and the support bracket is utilized to support and fix the reflector.

7. The backlight module according to claim 5, wherein the reflector has a bottom and there is a supporting distance between the bottom and the PCB, and the supporting distance is less than the light source distance.

8. The backlight module according to claim 5, wherein the reflecting layer has a curved surface.

9. The backlight module according to claim 8, wherein the curved surface is formed by a plurality of flat surfaces coupling each other.

10. The backlight module according to claim 8, wherein the curved surface is an arced surface.

11. A liquid crystal display (LCD), comprising a backlight module, wherein the backlight module comprises a light source and a PCB, the light source disposed on an inside of the PCB, the light source comprising a light output surface, the light output surface parallel to the PCB with a light source distance therebetween, the backlight module further comprising a reflector,
the reflector disposed beside the light source, and the reflector having a reflecting layer, wherein the reflecting layer is outward curved in an opposite direction of the PCB, and there is a maximum distance between the reflecting layer and the PCB, and the maximum distance is larger than the light source distance.

12. The LCD according to claim 11, wherein a support bracket is disposed between the reflector and the PCB, and the support bracket is utilized to support and fix the reflector.

13. The LCD according to claim 11, wherein the reflector has a bottom and there is a supporting distance between the bottom and the PCB, and the supporting distance is less than the light source distance.

14. The LCD according to claim 11, wherein the reflecting layer has a curved surface.

15. The LCD according to claim 14, wherein the curved surface is formed by a plurality of flat surfaces coupling each other.

16. The LCD according to claim 14, wherein the curved surface is an arced surface.
